(19) United States
(12) Patent Application Publication
(10) Pub. No.: US 2016/0063518 A1
(43) Pub. Date: Mar. 3, 2016

(54) SYSTEM AND METHOD FOR RANKING LEADS FROM TRANSACTIONAL DATA

(71) Applicant: Credibility Corp., Malibu, CA (US)

(72) Inventors: Wisdom Lu, Los Angeles, CA (US); Jeffrey M. Stibel, Malibu, CA (US); Aaron B. Stibel, Malibu, CA (US)

(73) Assignee: Credibility Corp.

(21) Appl. No.: 14/474,616

(22) Filed: Sep. 2, 2014

(51) Int. Cl. G06Q 30/02

(52) U.S. Cl. CPC G06Q 30/0201

(57) ABSTRACT

Some embodiments rank entities within a lead list to identify the quality of each lead. Each entity is ranked based on stability component and a transactional component. The stability component accounts for the size and years of operation of the lead. The transactional component accounts for the recency of purchases, total amount of purchases, and changes in spending behavior of the lead. The stability component and transactional component are then quantified into a lead rank score and presented in conjunction with the lead in the lead list.

### TECHNICAL FIELD

The present invention pertains to ranking the quality of leads that are provided as part of a lead generation service.

### BACKGROUND

Businesses rely on leads in order to sustain and grow their revenue. Leads identify entities that are in some aspect relevant to the business. These entities can include other businesses or individuals that are potential new customers or partners. In terms of potential new customers, leads identify entities that are interested in or in some capacity likely to purchase the goods and services of the business. In terms of potential new partners, leads identify entities that supplement the sale of the goods and services of the business. Partners can include suppliers, manufacturers, and marketers as some examples.

Any meaningful lead acquisition requires extensive market research and knowledge of business needs. This is because leads have to be relevant to a business in order to have any chance of conversion into an actual customer or partner. For example, a women's clothing business will want leads that target women likely in a certain demographic. Lead generation services perform the market research that identifies the potential customers and partners that are relevant to different businesses. Lead generations services are especially adept at finding potential customer and partner leads that are geographically or demographically relevant to a business. Businesses can then purchase lead lists from the lead generation services in order to obtain a list of relevant potential customers and partners they can market to or connect with without having to engage in the market research themselves.

The problem however is that a relevant lead is not necessarily a quality lead. Many lead generation services present all leads equally regardless of whether one lead has more money to spend than another, whether a lead is actually in need of the goods and services of a business, and whether the lead is actively operating. Thus, a business can purchase a lead list of relevant leads. However, the business may simply waste its resources marketing to these leads if none of the leads has the finances to purchase goods and services of the business. Accordingly, the difference between a quality lead and a relevant lead is that the quality lead has a higher likelihood of converting into an actual customer for or partner of the business.

There is therefore a need to decipher the quality of relevant leads in order to differentiate leads in varying degrees of quality with each degree indicative of a different likelihood of conversion. To this end, there is a need to rank leads in terms of the likelihood of a lead's ability and desire to spend in order to acquire goods and services.

### SUMMARY OF THE INVENTION

It is an objective of the present invention to define systems, methods, and computer software products for assessing the quality of leads and ranking the leads accordingly. To rank the leads, some embodiments compute a score for each lead. The score is indicative of a lead's stability and spending propensity which translates into a likelihood that the lead can be converted from a potential customer to an actual customer or from a potential partner to an actual partner. In other words, the lead rank score is representative of the quality of the lead. In some embodiments, the lead rank score of some embodiments is computed from a stability component and a transactional component.

The stability component assesses the quality of a lead based on any of the size of the lead (e.g., number of employees, number of locations, revenue, etc.) and the number of years that the lead has been in operation. The stability component is based on the premise that an established and larger sized entity is more likely to continue to operate in the future and is likely to consume more goods and services from third parties than a less established and smaller sized entity. In other words, an established and larger entity will have more funds and a greater need for goods and services than the newer and smaller entity. Thus, the premise is that the more established and larger sized entity is more likely to convert to a customer or partner than a newer and smaller sized entity. Accordingly, the established and larger entity will be scored as a higher quality lead than newer and smaller entities. In some embodiments, a stability component score is generated for each lead by aggregating entity stability data from various databases, governmental records, public disclosures, or from websites or disclosures of the entities being scored and by comparatively processing the stability data to produce a quantified value.

The transactional component assesses the quality of a lead based at least on the recency and total amount of the lead's purchases. The transactional component is based on the premise that a bigger spending entity has more capital and a greater need to purchase goods and services than an entity that has previously spent less and that the bigger spending entity will continue to spend more and have a greater need for goods and services of third parties in the future. Thus, the premise is that the bigger spending entity is more likely to convert to a customer or partner than an entity that has previously spent less. Accordingly, a lead with a greater number of recent purchases will be scored as a higher quality lead than one that has a fewer number of recent purchases. Also, a lead with a large aggregate spending total in a particular time period will be scored as a higher quality lead than one that has a smaller aggregate spending total in the same particular time period. In some embodiments, a transactional component score is generated for each lead by aggregating transactional data from various transaction processors and by processing the transactional data to produce a quantified value.

In some embodiments, the transactional component also accounts for changes in the spending patterns of a lead. Increased spending over multiple time intervals is again indicative of a lead looking to purchase more goods and services. As such, leads with increased spending over some monitored duration will be provided a higher rank score than leads with decreased spending over the monitored duration.

Some embodiments produce the lead rank score from the stability component and the transactional component of each entity. The lead rank score is an alphanumeric or symbolic representation of the quality of an entity, wherein lead quality indicates the likelihood that a lead will continue spending on goods and services of third parties which is an indication for the likelihood of the lead converting into an actual customer or partner. In some embodiments, the lead rank score is included with each lead in a lead list that is relevant to a business. The lead rank score may also be included as part of search results that meet user specified search criteria for relevant leads.

In some embodiments, the lead rank score can be used to price leads as different sellable assets. For example, users can pay different prices to obtain lead lists with more or less quality leads.

### BRIEF DESCRIPTION OF THE DRAWINGS

In order to achieve a better understanding of the nature of the present invention a preferred embodiment for the lead rank scoring system will now be described, by way of example only, with reference to the accompanying drawings in which:

FIG. 1 illustrates a lead list wherein each lead is provided a lead rank score to identify the quality of the lead in accordance with some embodiments.

FIG. 2 presents a process with which the lead rank scoring system generates lead rank scores in accordance with some embodiments.

FIG. 3 illustrates using the clustering methodology to produce the lead ranking score in accordance with some embodiments.

FIG. 4 presents a process with which the lead rank scoring system automatically generates relevant leads for a user in accordance with some embodiments.

FIG. 5 illustrates providing different quality filtered lead lists based on price.

FIG. 6 presents an exemplary interactive interface provided by the lead rank scoring system to facilitate lead generation and to select between different pricing tiers.

FIG. 7 illustrates a computer system with which some embodiments are implemented.

### DETAILED DESCRIPTION OF THE INVENTION

In the following detailed description, numerous details, examples, and embodiments of a lead rank scoring system and methods for ranking leads on the basis of quality are set forth and described. As one skilled in the art would understand in light of the present description, the system and methods are not limited to the embodiments set forth, and the system and methods may be practiced without some of the specific details and examples discussed. Also, reference is made to accompanying figures, which illustrate specific embodiments in which the invention can be practiced. It is to be understood that other embodiments can be used and structural changes can be made without departing from the scope of the embodiments herein described.

The lead rank scoring system of some embodiments determines the quality of potential customer and partner leads, wherein the quality determination is indicative of the likelihood that the lead will continue to operate and the degree with which it spends on the goods and services of third parties. The quality determination therefore identifies the likelihood that the lead can be converted into an actual customer or partner. In some embodiments, the system generates a lead rank score to quantify the quality of the lead. In some embodiments, the system uses the lead rank score to rank leads in a lead list so that the leads that have a higher likelihood of conversion are differentiated from other relevant leads in the lead list.

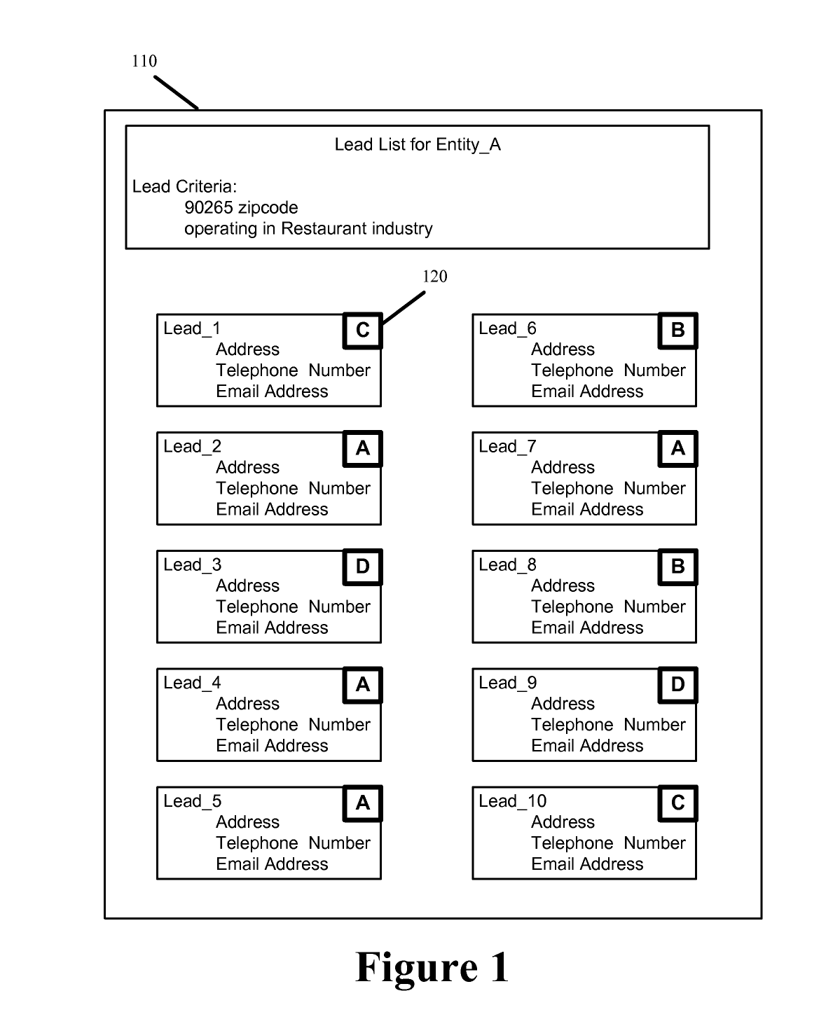

FIG. 1 illustrates a lead list wherein each lead is provided a lead rank score to identify the quality of the lead in accordance with some embodiments. The lead list 110 presents ten different entities that are identified to be relevant because they each satisfy user or system specified criteria. The criteria can specify different industry, geographic, demographic, financial, and identification classifications. However, it should be apparent the criteria can be specified using any data parameter that the lead rank scoring system or other lead generation service has available for the entities. Each lead in the list 110 is scored on an A, B, C, and D scale. The score is shown adjacent to each lead (see e.g., reference marker 120). The “A” score is indicative of a lead with the highest likelihood of continued operation and greatest spending. The “D” score is indicative of a lead with the lowest likelihood of continued operation and least spending. In other words, leads with the “A” score have a higher likelihood of conversion into an actual customer or partner than leads with a less score.

The recipient of the lead list 110 can concentrate its efforts on the leads with the highest lead rank scores that are likely to generate the highest return while making a lesser effort to contact the leads with the lowest rank scores. This saves the recipient time, money, and effort by allowing the recipient to better focus and prioritize its marketing efforts.

The lead rank scoring system produces each lead rank score from stability and transactional components. The stability component assesses the quality of a lead based on the likelihood of the lead continuing operation and an amount of goods and services the lead may require from third parties, whereas the transactional component assesses the quality of a lead based on its spending habits.

In some embodiments, the stability component of a lead or entity is determined at least from the size of the entity and the number of years that the entity has been in operation. The size of the entity can be determined from the entity's employee count, store location count, assets, credit, revenue, shipments, and inventory as some examples. The number of years that a business entity has been in operation can be determined from the year of incorporation, governmental filings, entity website, and online postings as some examples. The years in operation for an individual entity can be determined from its birth date, graduation year, years of employment, etc. The basic premise of the stability component is that larger entities that have been operating longer are typically more financial solvent than smaller entities or entities with fewer years in operation. Also, larger and more established entities typically have greater purchasing power and consumption than smaller entities and will continue to have greater need for third party goods and services than smaller and newer entities.

In some embodiments, the transactional component of a lead or entity is determined at least from the recency of purchases, the purchase amounts, and changes in the spending behavior of the entity. This information is obtained from transaction processors such as credit card payment processors and banks. The more purchases an entity makes, the greater the total of the purchases, and any increases in expenditures are all indicators that increase the likelihood that an entity is a quality lead with a higher conversion rate.

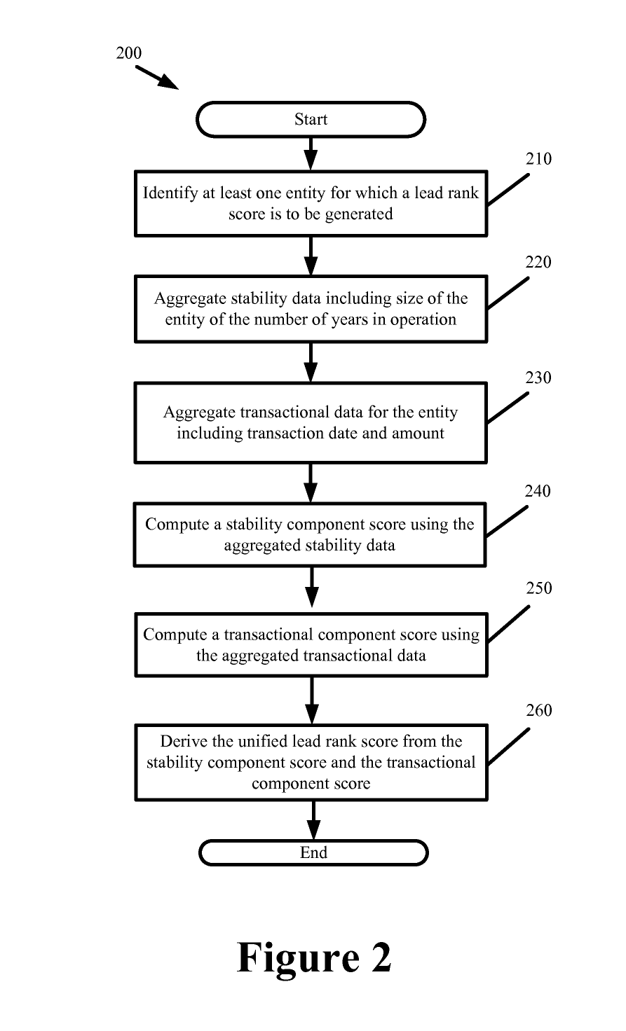

FIG. 2 presents a process 200 with which the lead rank scoring system generates lead rank scores in accordance with some embodiments. The process 200 begins by identifying (at 210) at least one entity for which a lead rank score is to be generated. This entity can be obtained from a lead list that lists several entities. In such cases, the process will repeat until a lead rank score is computed for all entities in the lead list. Alternatively, the process can begin in response to user search criteria that identifies one or more relevant leads that the user is interested in.

The process aggregates (at 220) stability data for the entity. As noted above, the stability data includes any of the size of the entity including number of employees, number of locations, revenue and the number of years the entity has been in operation. Other stability indicators that may be aggregated and used in determining the quality of the lead include the entity debt, payroll, size of land use, as well as the number of liens, judgments, or lawsuits against the entity. The lead rank scoring system aggregates the stability data from one or more databases, governmental sources, public disclosures, online postings, and data that is disseminated by the entity through its website or online profiles. Specifically, the lead ranking scoring system uses network interfaces and optionally data crawlers to obtain the data. In some embodiments, the lead rank scoring system maintains an entity database or partners with a lead generation service or information aggregator in order to obtain the stability data, wherein the entity database stores identifying information about different entities.

The process also aggregates (at 230) transactional data for the entity. As noted above, the transactional data includes data regarding transactions made by the entity. This data identifies when each transaction was made, the amount of the transaction, and potentially the good or service involved in the transaction. Moreover, this data can be collected and stored over a period of time so that the system can identify aggregate amounts spent over different time intervals and changes in spending behavior over the different time intervals. In some embodiments, the aggregated stability and transactional data for each entity is stored to a system database for use in identifying trends, changes, or deviations in the data over time.

The process computes (at 240) a stability component score using the aggregated stability data and computes (at 250) a transactional component score using the aggregated transactional data. Each score provides a different quality assessment of the entity. Each assessment provides an indication as to whether the entity will continue to spend and how much that entity will spend, and thus serve to indicate the likelihood that the entity can be converted to an actual customer or partner.

To increase the accuracy of the lead quality, the process uses the stability component score and the transactional component score to derive (at 260) the unified lead rank score of some embodiments. The lead rank score can then be included as part of a lead list or presented through an online interface in response to search criteria that identifies the entity that is scored.

In some embodiments, the component scores and the lead rank score are computed using a clustering methodology. By this methodology, each element of the stability and transaction components is quantified to a value. For example, a first entity that has been in business for ten years and has ten employees is assigned a first element score of seven for the years in business element and a second element score of two for the size element of the stability component. These scores can be produced based on predefined formulae that map data values to scores or that use a relative modeling to determine a data value to score conversion. The element scores are then aggregated. As part of the aggregation, the scores may be summed or averaged. Next, the aggregate score is compared relative to the aggregate score of other relevant entities. The other relevant entities may include, for example, entities from the same lead list, entities operating within a similar industry, entities operating within a specified geographic region, or some combination thereof. Based on the comparison of entity aggregate scores, different clusters of scores are identified and scored. Any entity whose aggregate score falls within a given cluster is assigned the score that is provided to that cluster. Some embodiments use a random forest model to produce the clusters and generate the scores therefrom.

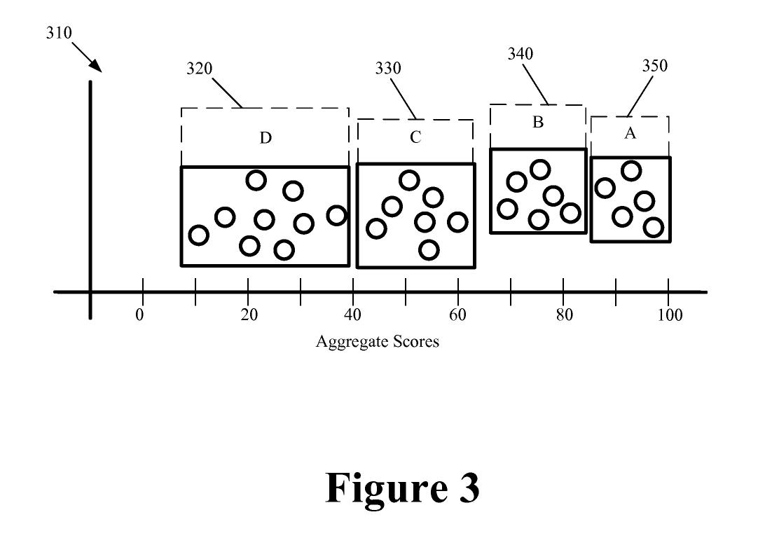

FIG. 3 illustrates using the clustering methodology to produce the lead ranking score in accordance with some embodiments. The figure illustrates the aggregate stability and transactional component scores for different entities plotted across a graph 310. Four different clusters 320, 330, 340, and 350 of plotted scores are then identified. Each cluster 320-350 is assigned a different lead rank score such that any entity with an aggregate score falling within a particular cluster is assigned the lead rank score for that particular cluster. Based on this clustering methodology, it should be apparent that the computation of an entity's lead rank score is not dependent solely on the value set of the entity, but is a relative computation that is derived based on the data sets and component scores of other entities.

In some embodiments, the lead ranking scoring system maintains its own database of leads and lead rank scores from which it creates custom lead lists that meet user specified criteria. Specifically, a user provides criteria for identifying relevant leads. The criteria can include any of an industry classification, geographic classification, demographic classification, or any data from any of the stability and transactional component elements as some examples. The system then scans the database to identify any leads that satisfy the user specified criteria. Those leads that satisfy the criteria are compiled into a lead list and a lead rank score is provided for each lead in the list using the techniques described above.

To improve the relevance of the leads that satisfy the user criteria, some embodiments filter the user criteria identified leads using the transactional data. In some other embodiments, the system automatically identifies relevant leads for a user that have a higher likelihood of conversion than leads identified based on user specified criteria.

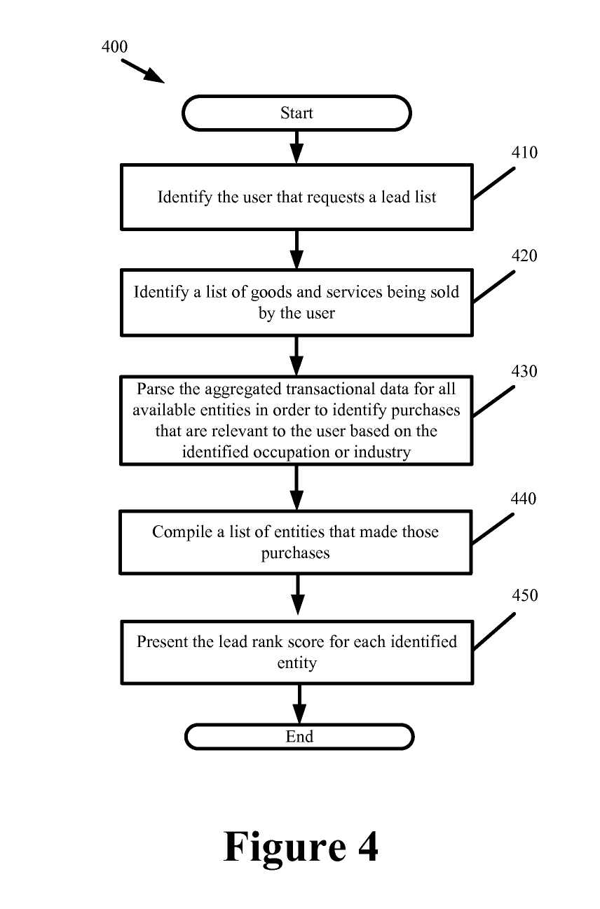

FIG. 4 presents a process 400 with which the lead rank scoring system automatically generates relevant leads for a user in accordance with some embodiments. By execution of process 400, the lead rank scoring system provides a complete lead generation service. The process 400 begins with the system identifying (at 410) the user that requests a lead list. This includes identifying the occupation or industry that the user is in.

From the user occupation or industry, the process identifies (at 420) a list of goods and services being sold by the user. This identification of the user's goods and services can be performed by scanning the user's website to identify goods and services, scanning aggregated transactional data for the user to identify goods and services being sold, retrieving a goods and services list of the user from a database, or by mapping the occupation or industry of the user to a list of commonly sold goods and services for entities in that occupation or industry. Alternatively, steps 410 and 420 of process 400 can be replaced with an input step whereby the user enters into the lead rank scoring system, a list of goods and services that it sells. In some such embodiments, the system provides an interactive display interface that the user uses to identify the goods and services it sells. Other criteria can also be entered through the interface, including geographic criteria that restrict the lead list to include entities that operate within a specified geographic region or industry criteria that restricts the lead list to include entities that operate within a specified industry.

Next, the process parses (at 430) the aggregated transactional data for all available entities in order to identify purchases that are relevant to the user based on the identified occupation or industry. The purchases are then back traced to compile (at 440) a list of entities that made those purchases. This list of entities has a far higher likelihood of conversion than prior art lead lists that would simply identify entities in a user identified industry regardless of whether or not those entities actually purchased goods and services that are being sold by the user.

As an example of process 400, a user may be identified as an automotive parts manufacturer. Accordingly, this user is interested not just in leads that operate in the automotive industry or automotive parts industry, but in leads that are actively purchasing automotive parts. From the processed transactional data, the system identifies and compiles a list of entities that purchase automotive parts.

To further improve the quality of the leads provided to the user, the process produces and presents (at 450) the lead rank score for each identified entity with the lead rank score identifying, in part from the transactional component of the lead rank score, those entities that have made a certain number of purchases or certain purchase total involving goods and services being sold by the user. From the example above, the transactional component of the lead rank score identifies which of the entities recently purchased automotive parts and the total amounts of those purchases in a given timeframe.

In some embodiments, the lead ranking system filters the lists according to the lead rank score. For example, the lead list from FIG. 1 can be filtered into four separate lists. A first filtered list includes only those leads that have an “A” lead rank score; a second filtered list includes only those leads that have a “B” lead rank score; a third filtered list includes only those leads that have a “C” lead rank score; and a fourth filtered list includes only those leads that have a “D” lead rank score. The lead ranking system can then sell the filtered lists at different prices. A user that wants a list of leads that only have an “A” lead rank score would pay more than a user that wants a list of leads having “C” or “D” lead rank scores.

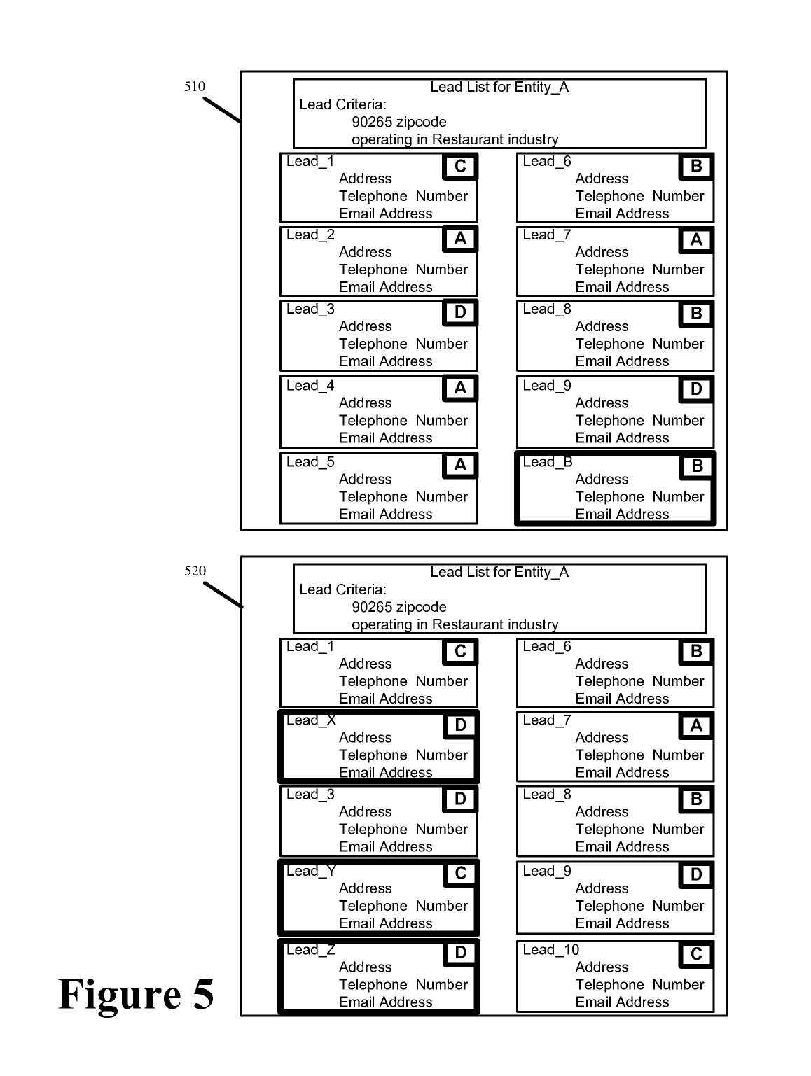

Different pricing tiers can also be used to limit the number “A”, “B”, “C”, and “D” quality leads that are included within a lead list. FIG. 5 illustrates providing different quality filtered lead lists based on price. The figure depicts two lead lists 510 and 520. These lead lists 510 and 520 are generated for the same user based on the same user criteria or system criteria. From the example above, the lead lists 510 and 520 may be generated to identify potential automotive parts buyers for the same user engaged in the manufacture of automotive parts. The user pays a first price to obtain the first lead list 510 with 10 total leads with 7 of the 10 leads being either “A” or “B” ranked leads and with the other 3 leads being either “C” or “D” ranked leads. The user can alternatively pay a second price that is less than the first price to obtain the second lead list 520 also with 10 total leads with 3 of the 10 leads being either “A” or “B” ranked leads and with the other 7 leads being either “C” or “D” ranked leads.

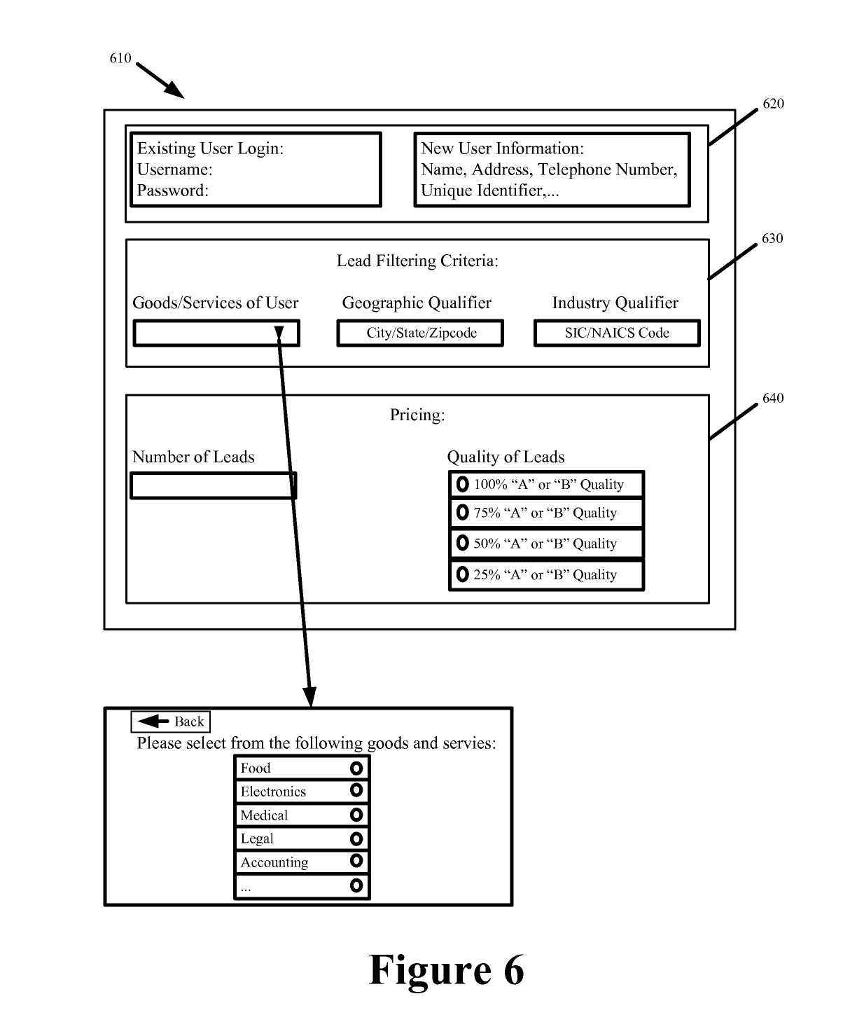

FIG. 6 presents an exemplary interactive interface provided by the lead rank scoring system to facilitate lead generation and to select between different pricing tiers. The interface 610 includes a first user identification field 620, a second criteria specification field 630, and a third pricing tier selection field 640.

Using the first user identification field 620, the user requesting the lead list identifies itself. This can include login information, a name, address, telephone number, or any unique identifier. In some embodiments, this field 620 may be optional.

The second criteria specification field 630 is the input field with which the user specifies qualifiers for identifying relevant leads. This can include geographic, industry, or demographic qualifiers. In some embodiments, the field 630 is a free form entry box or drop down list with which the user identifies the goods and services it offers for sale in order for the system to accurately identify relevant leads. In some embodiments, the second criteria specification field 630 is automatically populated with the goods and services offered for sale by the user based on the identification information entered in the identification field 620. Specifically, if the system is able to uniquely identify the user and the system already contains information about the goods and services offered for sale by the user or the geographic, industry, and demographic qualifiers that are relevant to the user, then the system can automatically enter that information to field 630.

The third pricing tier selection field 640 allows the user to customize the quality of the leads that are to be included in a resulting lead list. In other words, the user can select what percentage of the leads are “A” and “B” quality leads and what percentage are “C” and “D” quality leads. The user can also specify how many total leads it wants and based on the number, the system provides a cost for the lead list prior to generating the lead list.

In some embodiments, the lead rank scoring system is implemented using one or more computers having at least one processor and memory storing instructions for the processor to execute, wherein the instructions include instructions for implementing the processes described above. The system uses a network interface to aggregate the stability data and transactional data from which leads are scored and ranked. The system also includes various databases to store the aggregated stability and transactional data, the computed stability and transactional component scores, the computed lead rank scores, and, in some embodiments, the entities from which the lead lists are produced. The leads can include individuals and businesses.

Many of the above-described processes and components are implemented as software processes that are specified as a set of instructions recorded on a non-transitory computer-readable storage medium (also referred to as computer-readable medium). When these instructions are executed by one or more computational element(s) (such as processors or other computational elements like ASICs and FPGAs), they cause the computational element(s) to perform the actions indicated in the instructions, thereby transforming a general purpose computer to a specialized machine implementing the methodologies and systems described above. Computer and computer system are meant in their broadest sense, and can include any electronic device with a processor including cellular telephones, smartphones, portable digital assistants, tablet devices, laptops, desktops, and servers. Examples of computer-readable media include, but are not limited to, CD-ROMs, flash drives, RAM chips, hard drives, EPROMs, etc.

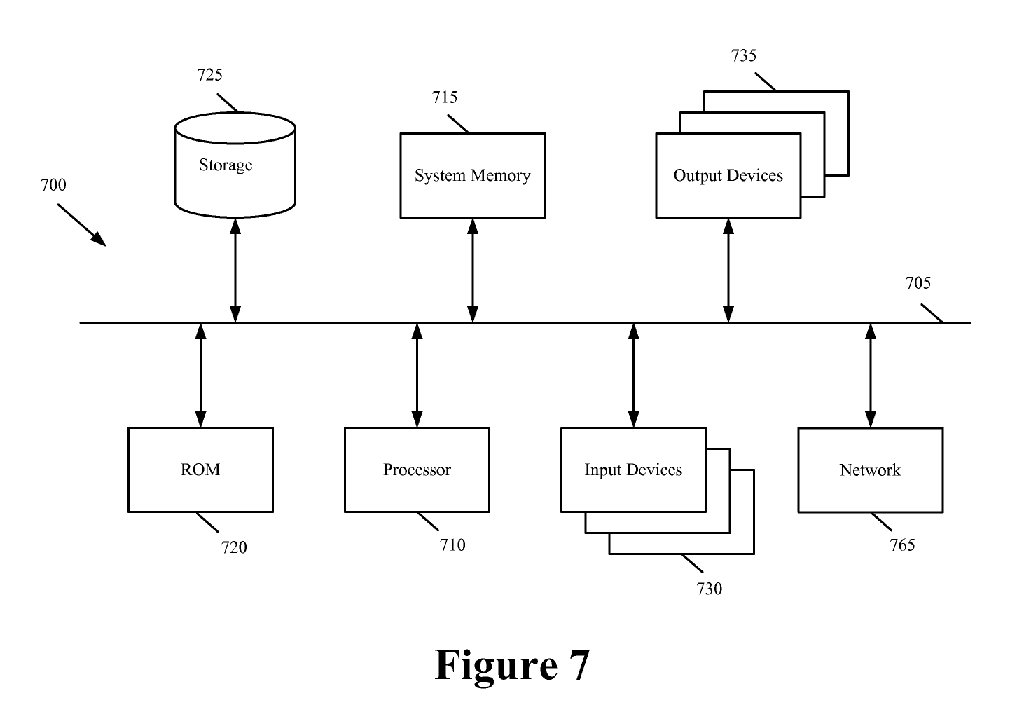

FIG. 7 illustrates a computer system with which some embodiments are implemented. Such a computer system includes various types of computer-readable mediums and interfaces for various other types of computer-readable mediums that implement the various processes, modules, and systems described above. Computer system 700 includes a bus 705, a processor 710, a system memory 715, a read-only memory 720, a permanent storage device 725, input devices 730, and output devices 735.

The bus 705 collectively represents all system, peripheral, and chipset buses that communicatively connect the numerous internal devices of the computer system 700. For instance, the bus 705 communicatively connects the processor 710 with the read-only memory 720, the system memory 715, and the permanent storage device 725. From these various memory units, the processor 710 retrieves instructions to execute and data to process in order to execute the processes of the invention. The processor 710 is a processing device such as a central processing unit, integrated circuit, graphical processing unit, etc.

The read-only-memory (ROM) 720 stores static data and instructions that are needed by the processor 710 and other modules of the computer system. The permanent storage device 725, on the other hand, is a read-and-write memory device. This device is a non-volatile memory unit that stores instructions and data even when the computer system 700 is off. Some embodiments of the invention use a mass-storage device (such as a magnetic or optical disk and its corresponding disk drive) as the permanent storage device 725.

Other embodiments use a removable storage device (such as a flash drive) as the permanent storage device. Like the permanent storage device 725, the system memory 715 is a read-and-write memory device. However, unlike the storage device 725, the system memory is a volatile read-and-write memory, such as random access memory (RAM). The system memory stores some of the instructions and data that the processor needs at runtime. In some embodiments, the processes are stored in the system memory 715, the permanent storage device 725, and/or the read-only memory 720.

The bus 705 also connects to the input and output devices 730 and 735. The input devices enable the user to communicate information and select commands to the computer system. The input devices 730 include any of a capacitive touchscreen, resistive touchscreen, any other touchscreen technology, a trackpad that is part of the computing system 700 or attached as a peripheral, a set of touch sensitive buttons or touch sensitive keys that are used to provide inputs to the computing system 700, or any other touch sensing hardware that detects multiple touches and that is coupled to the computing system 700 or is attached as a peripheral. The input devices 730 also include alphanumeric keypads (including physical keyboards and touchscreen keyboards), pointing devices (also called “cursor control devices”). The input devices 730 also include audio input devices (e.g., microphones, MIDI musical instruments, etc.). The output devices 735 display images generated by the computer system. The output devices include printers and display devices, such as cathode ray tubes (CRT) or liquid crystal displays (LCD).

Finally, as shown in FIG. 7, bus 705 also couples computer 700 to a network 765 through a network adapter (not shown). In this manner, the computer can be a part of a network of computers such as a local area network (“LAN”), a wide area network (“WAN”), or an Intranet, or a network of networks, such as the internet. For example, the computer 700 may be coupled to a web server (network 765) so that a web browser executing on the computer 700 can interact with the web server as a user interacts with a GUI that operates in the web browser.

As mentioned above, the computer system 700 may include one or more of a variety of different computer-readable media. Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable blu-ray discs, and any other optical or magnetic media.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

1. A machine-implemented method for assessing lead quality, the method comprising:
providing an interface to a user over a network, wherein the user submits lead criteria to a lead generation server using said interface, wherein the lead criteria identifies leads desired by the user, the lead generation server comprising a microprocessor, a network interface that provides said interface to the user over the network, and a memory that stores information about a plurality of entities, wherein the microprocessor
identifies, a set of leads from the plurality of entities stored to said memory that satisfy said lead criteria submitted by the user through said interface;
aggregates transactional data from a plurality of transaction processors over the network to said memory using the network interface, the transactional data relating to a plurality of transactions made by each lead of the set of leads, the transactional data identifying any of a purchase amount and date for each transaction of the plurality of transactions;
determines for each lead in the set of leads, (i) a likelihood of continued future operation and (ii) lead spending behavior, wherein the likelihood of continued future operation by a lead is determined in part based on at least one of a size of the lead and a duration the lead has been in operation;
ranks a quality of each lead in the set of leads based on the likelihood of continued future operation and the spending behavior of each lead, wherein ranking lead quality based on the likelihood of continued future operation is determined in part from order of largest sized lead to smallest sized lead or order of longest duration in operation to shortest duration in operation, and wherein ranking lead quality based on the spending behavior is determined in part from order of largest increase in purchase amounts by a lead over a specified time period to largest decrease in purchase amounts by a lead over the specific time period; and
outputs over the network to the interface provided to the user, a lead list comprising the set of leads with each lead of the set of leads qualified according to said ranking with said ranking indicating the likelihood that each lead can be converted into an actual customer or partner of the user.

2. The method of claim 1, wherein ranking the quality of each lead comprises computing a ranking score for each lead of the set of leads based in part on at least one of the size and the duration in operation for each lead.

3. The method of claim 2, wherein providing the lead list comprises providing a listing of each lead from the set of leads with the corresponding ranking score for that lead.

4. The method of claim 1, wherein the lead criteria comprises at least one of a geographic filter identifying one or more geographic regions that each lead of the set of leads must operate within and an industry classification identifying one or more industries that each lead of the set of leads must operate within.

5. The method of claim 1, wherein the size of a lead is based on one of (i) a number of employees and (ii) revenue for the lead.

6. (canceled)

7. The method of claim 1, wherein ranking lead quality based on the lead spending behavior is further determined in part from at least one of a total amount spent and recency of purchases made by each lead of the set of leads as identified from the transactional data.

8. The method of claim 1, wherein the microprocessor further computes a quality score quantifying quality of a lead based on purchases in the plurality of transactions that are made by the lead and any of the lead size and the duration the lead has been in operation.

9. The method of claim 1, wherein outputting the lead list comprises generating a first lead list at a first purchase price and a second lead list at a second purchase price, wherein the first purchase price is greater than the second purchase price, wherein the first lead list includes at least a minimum number of leads from the set of leads with a quality ranking that exceeds a quality threshold, and wherein the second lead list does not include the minimum number of leads from the set of leads with a quality ranking that exceeds the quality threshold.

10. A machine-implemented method for assessing lead quality, the method comprising:
providing an interface to a user over a network, wherein the user submits lead criteria to a lead generation server by way of said interface, wherein the lead criteria identifies leads desired by the user, the lead generation server comprising a microprocessor, a network interface that provides said interface to the user over the network, and a memory that stores information about a plurality of entities, wherein the microprocessor
identifies a set of leads from the plurality of entities stored to said memory that satisfy lead criteria submitted by the user through said interface;
aggregates from a plurality of transaction processors over the network to said memory using the network interface, transactional data for a plurality of purchase transactions made by each lead of the set of leads, wherein the transactional data identifies at least one of a purchase amount and date of purchase for each transaction of the plurality of purchase transactions;
identifies from the transactional data, an increase in purchase amounts made by a first lead of the set of leads over a specified time period and a decrease in purchase amounts made by a second lead of the set of leads;
ranks each lead in the set of leads in order of leads with most recent transactions or greatest total amount of transactions as identified from the transactional data, wherein said ranking comprises increasing the ranking of the first lead in accordance with the increase in the purchase amounts made by the first lead and decreasing the ranking of the second lead in accordance with the decrease in the purchase amount made by the second lead; and
outputs over the network to the interface provided to the user, a lead list comprising the set of leads with each lead of the set of leads qualified according to said ranking with said ranking indicating the likelihood that each lead can be converted into an actual customer or partner of the user.

11. The method of claim 10, wherein the microprocessor further computes a first-score to quantifiably represent the ranking of each lead in the set of leads.

12. The method of claim 10, wherein the microprocessor further identifies goods or services sold by the user.

13. The method of claim 12, wherein the lead criteria comprises goods or services sold by the user, and wherein identifying the set of leads from the plurality of entities comprises (i) aggregating transactional data identifying purchases made by any of the plurality of entities and (ii) identifying from the transactional data of the plurality of entities, at least two entities that purchase a good or service that is sold by the user as a lead of the set of leads and by excluding from the set of leads any entity that does not purchase a good or service of the user.

14. The method of claim 10, wherein outputting the lead list comprises generating the lead list identifying the set of leads and a ranking for each lead of the set of leads.

15. The method of claim 10, wherein outputting the lead list comprises generating the lead list identifying the set of leads and a score quantifying the ranking of each lead of the set of leads.

16. (canceled)

17. (canceled)

18. (canceled)

19. (canceled)
